(19) United States
(12) Patent Application Publication
(10) Pub. No.: US 2005/0193875 A1
(43) Pub. Date: Sep. 8, 2005

(54) TEMPORARY SELF LOCKING DRILL BIT

(76) Inventor: Jackie E. Sheriff, Savannah, GA (US)

Correspondence Address: GREENBERG & LIEBERMAN, 314 PHILADELPHIA AVE., TAKOMA PARK, MD, 20912, US

(21) Appl. No.: 10/708,459

(22) Filed: Mar. 4, 2004

(51) Int. Cl. B25B 23/08

(52) U.S. Cl. 81/460

(57) ABSTRACT

A fastening system comprised of a drill bit containing a slightly tapered spiral orion twist configuration at its driving end, and a matching fastener screw whose head contains a matching spiral orion twist recess. The drill bit is inserted within the center of the recess and is rotated 22½° clockwise so that the side edges of the drill bit's orion twist driving end meet and lock with the side walls of the matching spiral orion twist recess. The union between the drill bit and recess walls of the screw fastener allows for momentary locking, yet still allows for proportional transfer of torque thus reducing stress on a user, drill bit, screw fastener, as well as provide for easy disengagement of the drill bit and screw.

### BACKGROUND OF INVENTION

1. Field of Invention

The present invention relates to a fastening system that consists of a drill bit and a customized fastener screw, more particularly a combination system in which the driving end of the drill bit locks on to the head of a fastener screw, thus causing minimal slippage of the driver from the fastener screw, as well as easy application/disengagement of system when desired by user.

2. Background of the Invention

Often self-tapping threaded fasteners and drilling devices are used to fasten materials together. Yet many of these devices/systems often fall short of making the drilling process a completely efficient endeavor. For example, in conventional fastening systems, such as usage of a standard screwdriver and screw, the screwdriver often slips out of the recess in the screw head, especially when the recess is in the shape of a single groove. The slippage occurs frequently with this particular screw fastener because in the recess, the clearance between the screwdriver and screw is so large that it gives ample space for the driver to easily slip through.

U.S. Pat. No. 6,526,851 issued to Richard D. Fuerle on Mar. 4, 2003, shows a drill bit with a matching screw with a simple straight forward shape; but, unlike the present invention, Fuerle's device does not employ a locking system to hold the drill bit and screw firmly in place and instead features a matching screw with a recess similar to the recess of single groove screw configurations Thus, Fuerle's device causes the bit to have a high probability of disengaging from the head of the screw while in use.

To avoid slippage while using a conventional screwdriver, a user usually holds the screw with one hand while operating the driving tool with the other, thus making the drilling operation difficult as the screw is often dropped, requiring reapplication and wasted effort by the user.

An alternative to the conventional fastening system, a screwdriver and screw, is the usage of a power screwdriver, which is used often when large number of screws need to be fastened. One of the great advantages of power screwdrivers is the great amount of torque they can apply to screws, allowing screws to be fastened more quickly than if one were operating a manual screwdriver. Yet the speed a power screwdriver operates at often causes the drill to slip off the fastener head during the start or last few turns in driving a fastener into place or removing the fastener. The slippage caused by applying high force can scratch and ruin the surface of the screw. Such marring expands the walls of the recess, causing slippage to occur more frequently and furthermore causing prevention of its reoccurrence to be almost impossible at that point.

Axial pressure is often an attempt to reduce slippage by preventing the driving end from slipping out and over the walls of the recess in a fastener head. Yet application of extensive axial pressure on a screw is often undesirable because not only does it require more force to be applied by the user, but if slippage does occur, it occurs with great force and can damage the surface of the material being fastened. This problem is can cause severe damage to surfaces, and thus, axial pressure must be avoided when working with finished hardwood surfaces where the screwdriver blade can easily scratch or damage the piece.

Interlocking fastening systems consisting of drivers and fasteners have been engineered to solve some of the problems listed previously. U.S. Pat. No. 5,868,049 issued to Mammohan S. Kanwal on Feb. 9, 1999, shows a screw and driver system that interlocks through an hourglass shape on both driver and screw, yet unlike the present invention, the driver does not contain a tapered end to ensure an easy release when the user prefers. And unlike the present invention, Kanwal's device does not prevent permanent interlocking.

Also, unlike the present invention, many devices such as U.S. Pat. No. 5,868,049 issued to Mammohan S. Kanwal on Feb. 9, 1999, contact and transfer torque along a limited area causing stress and substantial wear on the driver and fastener, and/or employ the fastener and driver to be so tightly locked together that when the drilling operation is finished the user must use excessive force to unlock the driver from the fastener.

Thus there is a need for an invention that is efficient to use by preventing the slippage of the driver from the fastener, causes no wear on the driver and fastener, yet disengages easily when the drilling process is finished.

### SUMMARY OF INVENTION

The present invention improves upon the various previous methods of fastening and cited patents by being effortless to use, possessing features that will reduce slippage and wear, as well as providing a swift and efficient interaction between a screw fastener and drill bit.

The present invention accomplishes these objectives through a fastening system that has a drill with an orion twist pattern at its driving end and a screw fastener, whose head contains a matching orion twist recess. The drill bit is designed to fit any standard power-drilling tool, due to its hexagon shape on the non-driving end.

After attachment to a drilling tool, the drill bit is inserted into the orion twist recess on the screw fastener head and rotated at a 22½° clockwise turn, so that it locks tightly on the screw fastener head. Slightly tapered on the driving end, the drill bit may slide effortlessly into the screw fastener head and lock with ease.

More specifically in the present invention, the screw fastener has a tube shaped treaded shaft and a rounded flat head. The screw fastener head encompasses an orion twist shaped recess in the center of the head.

The matching drill bit employed by this invention comprises of a shaft having an orion twist configuration at its drilling end. The drill bit, when attached to the driving tool, is rotated about 22½° so that the side edges of the drill bit engage the complementary side walls in the orion twist recess of the screw fastener head. This rotating action provisionally locks the drill bit to the screw fastener head, thus preventing detachment and slippage.

Given the slight taper of the drill bit, proper positioning and aligning of the drill bit and screw fastener is immediately obtained when the two entities are first in contact with one another. The slight taper of the drill bit also allows for appropriate and easy detachment of the drill bit from the screw fastener, when the user is finished operating the drilling tool.

Locking of the screw fastener and drill bit prevents slippage of the driving tool from the fastener. As a result the screw fastener can be used on any material surface, without flying off the driving tool. Even though the drill bit and screw fastener are firmly interlocked, the slight taper of the drill bit permits appropriate space to proportionally distribute rotational force on a screw fastener, thus creating less deterioration of the drill bit and screw fastener.

### BRIEF DESCRIPTION OF DRAWINGS

FIG. 1 is a top view of the head of the recessed screw of the present invention.

FIG. 2 is a perspective view of the drill bit of the present invention.

FIG. 3 is a perspective view showing the drill bit together with the recessed screw of the present invention.

### DETAILED DESCRIPTION

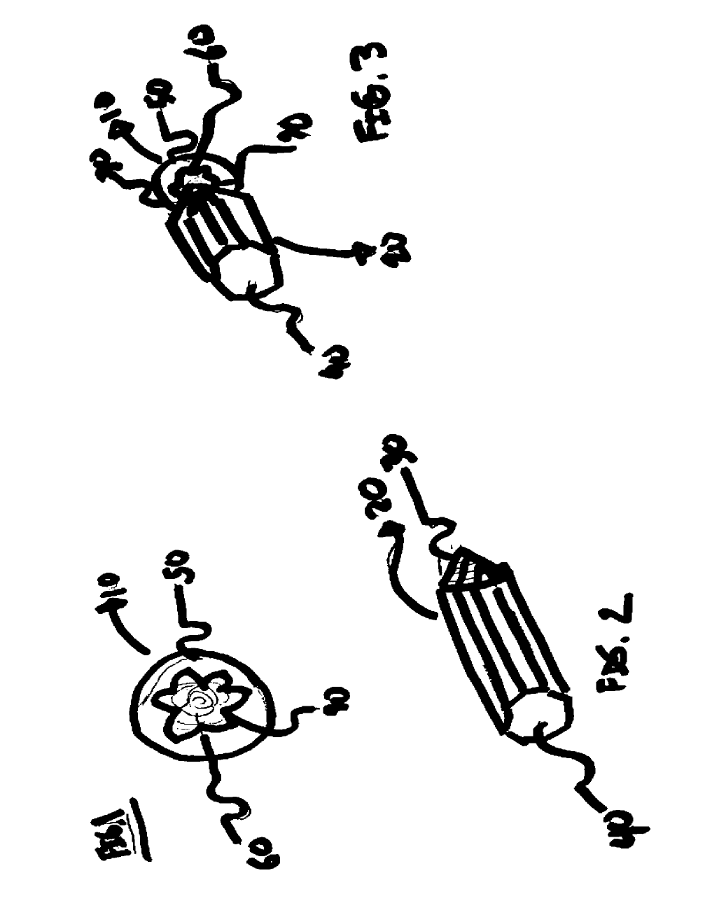

Referring to FIGS. 1-3 the present invention is a fastening system comprised of a screw fastener 10 in combination with a drill bit 20 that can be attached to a power-drilling tool. The drill bit 20 involves a tube shape shaft that is tapered on the driving end 30. On the opposite end, the drill bit contains a hexagon shaped flat plate finish 40, which can be attached to any standard power drill.

The threaded screw fastener 10 employed by the present invention includes a circular head 50, which can be of a convex or flat shape and an orion twist shaped recess 60 present in the center of the screw fastener head 50.

The drill bit 20 and screw fastener 10 are formed of a metal material, preferably steel. Such a metal, allows the screw fastener to be strong enough to handle the high force applied through the use of the drill bit 20 and power drilling tool, yet is lightweight enough to prevent the surface material from being tarnished by the pressure. A steel drill bit 20 will also be strong enough to lock with the screw fastener 10, allowing the user to fasten a surface without holding down the screw fastener 10. The drill bit 20 and fastener screw 10 of the present invention can be used in several drilling applications, including plywood floors.

The present operation of the drill bit 20 and screw fastener 10 depicted in FIGS. 1-3 is simple and efficient to complete. The drill bit 20 is inserted into the spiral orion twist recess 60 formed in the screw fastener head 50. In order to lock the drill bit 20 and screw fastener 10 together, the drill bit 20 is rotated 22½° clockwise, so that the drill bit 20 engages the side wall 70 of the spiral orion twist recess 60 of the screw fastener head 50. As a result the drill bit 20 locks with the screw fastener 10.

There are several key advantages in the structure of the present invention. The recess 60 is geometrically shaped in the figure of a spiral orion twist, so that when the drill bit 20 makes contact with the screw fastener 10, the sidewalls 70 of the orion twist recess 60 grip the drill bit 20 firmly providing lockage. The spiral orion twist recess 60 allows the drill bit 20 and the screw fastener 10 to mate by locking easy, thus avoiding the slippage which is common in conventional screws where the recess is in the form of a simple groove or simple X figure. For that reason, the present invention provides a firm hold between the drill bit 20 and custom designed screw fastener 10, in order that the user doesn't have to stress about holding down the screw fastener 10 manually while drilling. Once the drill bit 20 and screw fastener 10 have mated, the two entities will remain locked and connected. This prevents slippage and allows the user the ease of not having to concentrate on holding down the screw faster 10 and drilling simultaneously. Instead the present invention permits the user to simply focus on the uncomplicated complete act of drilling.

Although the drill bit 20 and screw fastener 10 are firmly locked together, the screw fastener 10 and drill bit 20 are geometrically shaped so that there is a large enough surface area to distribute torque proportionally, as a result eradicating wear and tear on the fastener or drill bit. This aspect is important because when high torque, such as the force of a power drill, is applied to a small confined area, such as the small single groove in a conventional screw, the force bends and destroys the walls of the screw recess. Usage of such conventional drilling screws, consequently, causes the drill bit and the screw to mate difficulty often resulting in the drill bit flying off the screw head. This ultimately forces the user to waste energy by holding the screw firmly down manually, in order to finish drilling. Given that the recess of the present invention is figured as an orion twist, the high torque applied to the screw fastener 10, travels in a path around a central point, while continuously receding from and approaching the center. An arrangement such as this is desirable because energy is distributed all around the surface area of the screw fastener 10 and not confined to a single tight space. As a result, allowing the screw to remain intact and unharmed in the drilling process, as well as making the drilling process efficient and smooth.

The slightly tapered driving end 30 of the drill bit 20 allows the user to insert the drill bit 20 with ease into the recess 60 of the screw fastener 10 head 50 and align the drill bit 20 in the sidewalls 70 of the spiral orion twist recess 60. This aspect is important because although it is vital that the drill bit 20 and the screw fastener 10 interlock, if the drill bit 20 was absent of a tapered driving end 30 the user would have to slowly carefully align the drill bit 20 with the sidewalls 70 of the screw fastener recess. As well as apply reasonable force to push the drill bit 20 into the recess 60 in order to connect the drill bit 20 and screw fastener 10. Thus the user would waste considerable energy and time in the drilling process.

A tapered driving end 30 is also preferable because although it is vital that the drill bit 20 and screw head 50 interlock, when high torque is applied the two entities could wind exceedingly tight together that it would be hard to unlock the drill bit 20 from the screw fastener 10 when the user is finished drilling the screw fastener 10 in place. Therefore, the present invention employs a drill bit 20 with a tapered driving end 30 so that even though high torque is applied to the screw fastener 10 and drill bit 20 as they are interlocked, there is enough room as a result of the tapered driving end 30, the drill bit 20 and the screw fastener 10 will not be subsequently tightly locked that the user must pull with force the drill bit 20 out of the fastened screw fastener 10 when drilling is complete.

The present invention has benefits not present in other known fastening systems in that the present invention allows the user to fasten a material, spread high torque evenly, eliminate destruction on screw fasteners, as well as easily use/disengage the drill bit and screw fastener, while not holding down the screw fastener 10.

It is intended and should be understood that the invention is not limited to the particular embodiment revealed and the previous description of the invention is merely to be illustrative and that the invention will include other embodiments and alterations that fall within the appended claims.

1. A screw fastener and matching drill bit combination comprising:
a screw rotatable about a spiral axis that includes a circular convex shaped head with an orion twist shaped recess located in the center; and
a drill bit, which communicates with said screw, formed with a slightly tapered orion twist configuration driving end and a body culminating in a hexagon end.

2. The screw fastener and matching drill bit combination of claim 1 wherein said drill bit communicates with said recess of said screw to lock after turning at a 22½° to 35° angle.

3. he screw fastener and matching drill bit combination of claim 1, wherein said said tapered driving end of said drill bit has a length of ¼ to 1 inch.
